(19) United States
(12) Patent Application Publication
(10) Pub. No.: US 2010/0245836 A1
(43) Pub. Date: Sep. 30, 2010

(54) Low-cost, compact, & automated diabetic retinopathy diagnostics & management device

(76) Inventors: Manish D. Kulkarni, Fremont, CA (US); Balasigamani Devaraj, Morgan Hill, CA (US)

Correspondence Address: Manish Dinkarrao Kulkarni, 1400 Stone Pine Terrace, Apt. 316, Fremont, CA, 94536, US

(21) Appl. No.: 12/732,484

(22) Filed: Mar. 26, 2010

Related U.S. Application Data
(60) Provisional application No. 61/163,872, filed on Mar. 27, 2009.

(51) Int. Cl. G01B 9/02

(52) U.S. Cl. 356/479

(57) ABSTRACT

A Diabetic Retinopathy Diagnostic system based on OCT which will map 3-D blood circulation including velocity information with micron-scale resolution in the retina is disclosed here. The system leverages the advancements in telecommunication and device technologies and employs novel Doppler algorithms. For example, the reference arm in the interferometric system can be a fiber-optically integrated Faraday rotating mirror. By way of example, but not limitation, typically, the light in the detection arm of the Michelson interferometer can be measured using a Volume phase holographic dispersion grating. By way of example, but not limitation, the dispersed light can be focused on a line-scan camera or multi-line 2-D camera.

### 1 CROSS-REFERENCE TO RELATED APPLICATIONS

This patent application claims the priority filing date of the provisional US patent application (Application No. 61/163,872) titled “Low-cost, compact, & automated diabetic retinopathy diagnostics & management device,” filed on Mar. 27, 2009 by the inventor Manish D. Kulkarni. This benefit is claimed under 35. U.S.C. $119 and the entire disclosure of the Provisional U.S. patent Application No. 61/163,872 is incorporated here by reference.

### 2 BACKGROUND

2.1 Field

The following description relates to optical test & measurement, interferometry, optical ranging and imaging, optical coherence domain reflectometry (OCDR), optical frequency domain reflectometry (OFDR), optical coherence tomography (OCT), Doppler processing and Doppler OCT in general.

2.2 Background

Optical Coherence Domain Reflectometry (OCDR) has been playing a major role in industrial and scientific metrology and medical diagnostics. Optical Coherence Tomography (OCT) is a 2-D extension of OCDR and provides micron-resolution cross-sectional images of any specimen. Most of the industrial and clinical OCDR and OCT machines are expensive, cumbersome to use, bulky, not very efficient and are fragile. OCT is able to image sub-surface retinal microstructure and has been useful for diagnosis & management of diabetic retinopathy. Abnormalities in blood-flow circulation due to diabetes is the root cause behind retinal microstructure damage. However, no clinical tools exist that can perform functional and velocity mapping of blood vessels in the retina for tracking early development of diabetic eye diseases. Therefore, there is a need for an automated, low-cost and compact tool based on Doppler OCT for tracking progression & management of diabetic retinal diseases by performing 3-D functional mapping of blood circulation in the retina. Such a device will be extremely useful in detecting earliest signs of diabetic retinopathy and hence it will be an ideal tool for screening diabetic patients at risk of developing retinopathy. Since it has been proven that glucose and blood-pressure control are the best methods for managing diabetic retinopathy, our Doppler OCT system will be an ideal low-cost tool, which will permit screening as well as management for the disease. The invention presented here provides such a system and addresses these issues.

### 3 SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

A Diabetic Retinopathy Diagnostic system based on OCT which will map 3-D blood circulation including velocity information with micron-scale resolution in the retina is disclosed here. The system leverages the advancements in telecommunication and device technologies and employs novel Doppler algorithms.

By way of example, but not limitation, the reference arm in the OCT system can be a fiber-optically integrated minor. By way of example, but not limitation, such a mirror can be a Faraday rotating mirror. By way of example, but not limitation, typically, the light in the detection arm of the Michelson interferometer can be measured using a dispersion grating. By way of example, but not limitation, this light can be dispersed using a Volume phase holographic grating. By way of example, but not limitation, the dispersed light can be focused on a line-scan camera or multi-line 2-D camera.

By way of example, but not limitation, the signals from the camera can be processed using Doppler algorithms to extract velocity information simultaneous with structural information.

Toward the accomplishment of the foregoing and related ends, the one or more embodiments comprise the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed and the described embodiments are intended to include all such aspects and their equivalents.

### 4 BRIEF DESCRIPTION OF THE DRAWINGS

FIG. 1 is a block diagram of an OCDR-OCT system in accordance with an embodiment of the present invention; the key novel elements being volume phase holographic grating, Faraday rotator mirror, fiber stretcher, and (⅛)th waveplate.

FIG. 2 is a block diagram of a system similar to that in FIG. 1 except that the Faraday rotator mirror is replaced by a fiber optically integrated mirror, and the (⅛)th waveplate is eliminated and a polarization compensator is introduced.

FIG. 3 is a block diagram of a system similar to that in FIG. 2 except that the fiber optically integrated mirror is replaced by a free space mirror.

FIG. 4 is a block diagram of a system similar to that in FIG. 1 except that the broad-band source is replaced by a tunable frequency source, detector array is replaced by a single high-speed detector, and the diffraction grating is eliminated.

FIG. 5 is a block diagram of a system similar to that in FIG. 1 except the (⅛)th waveplate is eliminated and a polarization compensator is introduced in the sample arm.

### 5 DETAILED DESCRIPTION

### 5.1 Optical Coherence Tomography (OCT)

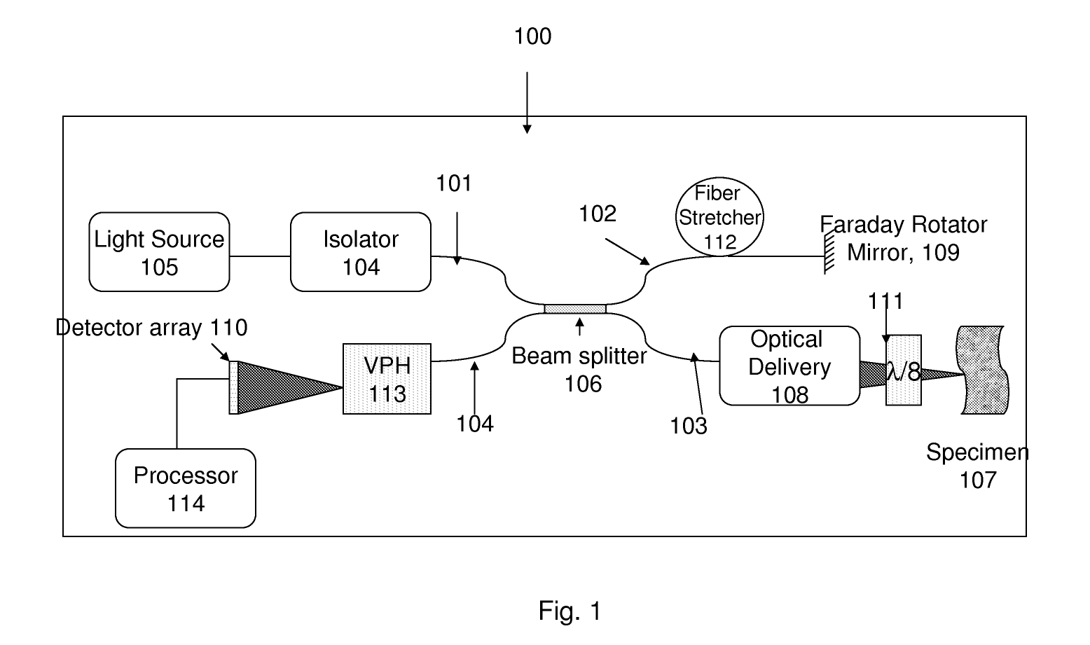

Optical coherence tomography (OCT) is similar to ultrasound imaging in that cross-sectional images of micro-features are acquired from adjacent depth resolved reflectivity profiles of the tissue (FIG. 1). OCT employs a fiber optically integrated Michelson interferometer illuminated with a short coherence length light source such as a superluminiscent diode (SLD). The interferometric data are processed in a computer and displayed as a gray scale image. In an OCT image, the detectable intensities of the light reflected from human tissues range from 10⁻⁵ to 10⁻¹¹ th part of the incident power.

Recent OCT systems use spectroscopic detection. Basically the interferometric light exiting the detector arm is dispersed via a grating. The spectra are acquired using a line-scan camera. The resulting spectra are typically (by way of example, not by limitation) transferred to a processor for inverse Fourier transforming and relevant signal processing (such as obtaining the complex envelope of the interferometric signal) for obtaining depth dependent (i.e., axial) reflectivity profiles (A-scans). The axial resolution is governed by the source coherence length, typically ˜3-10 μm. Two dimensional tomographic images (B-scans) are created from a sequence of axial reflectance profiles acquired while scanning the probe beam laterally across the specimen or biological tissue.

### 5.2 Medical Applications

Optical coherence tomography (OCT) is fast becoming a gold standard for diagnosis & management of ophthalmic diseases, retinal diseases & glaucoma. Our innovative OCT diagnostic system leverages advancements in photonics devices for telecom. This enables us to supply the global market a low-cost, portable & robust OCT imaging tool, which would be affordable to general physicians & optometrists and other health personnel.

### 5.3 OCT-OCDR System in Our Invention

In FIG. 1, a block diagram of our proposed OCT-OCDR Interferometer system 100 is illustrated. The interferometer has source arm (101), reference arm (102), sample arm (103), and detection arm (104). In some embodiments of our invention, (by way of example but not by limitation) a broad-band light source 105 operating at a suitable center wavelength is used. In the interferometer, the source light is separated into the sample and reference arms using a fiber optic beam splitter 106 (typically 50/50 by way of example, but not by limitation). The sample arm 103 consists of a probe, which focuses light into the specimen 107 using an optical delivery unit 108 and collects the backscattered light.

5.3.1 Faraday Rotator Mirror

In typical state-of-the-art OCT systems, light exits a fiber tip in the reference arm and the light returns from a retroreflecting mirror mounted in air. This increases system complexity and bulkiness. In some embodiments of our invention, a fiber-optically integrated Faraday Rotator mirror 109 in the reference arm 102 of the OCT-OCDR interferometer system 100 can be used. Faraday rotator mirrors were first used in Michelson interferometer for defense applications. Since the polarization of the retroreflected light is orthogonal to the incident light, fiber birefringence effects effectively get cancelled in the reference arm 102. Currently, Faraday rotator mirrors integrated with the fiber tip are being widely used in telecom. This will permit use of cheap devices meeting Telcordia Standards within the OCT instrument. Please see Table 1 for a summary.

The waves reflected back from the sample arm 103 and the reference arm 102 interfere at the detector array 110. Since the interference signal is only created when the polarization in the reference arm 102 matches with that in the sample arm 103, in some embodiments, one can include by way of example but not by limitation a 45 degrees Faraday rotator 111 in the sample arm 103 just before the light is incident on the specimen 107. Such a Faraday rotator is also known as a AA waveplate. Since the polarization of the retroreflected light will be almost orthogonal to the incident light (considering the fact that the birefringence in the specimen will modify the polarization state), the birefringence effects in the sample arm fiber 103 of the interferometer 100 will get cancelled.

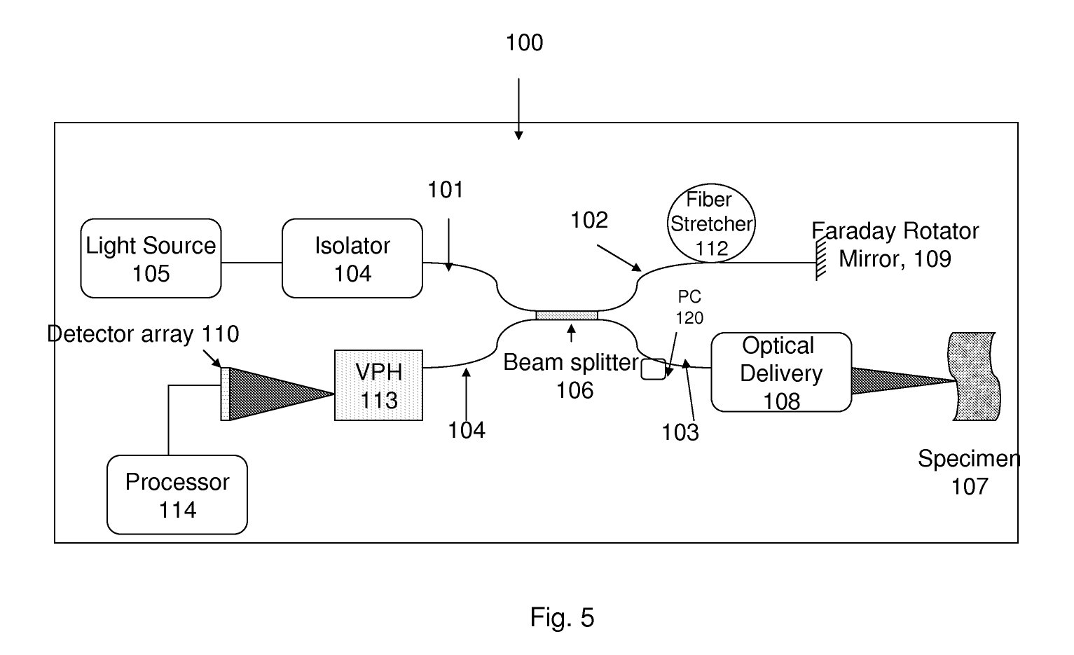

In some embodiments, another way of achieving the polarization matching is to use a polarization compensator 120 as shown in FIG. 5 instead of using a waveplate. In other embodiments, combinations of waveplates and polarization compensators can be used to achieve the desired polarization matching.

Typical OCT systems need to dynamically adjust polarization (before each patient exam) in the sample arm 103 in order to match with polarization in the reference arm. We will not need dynamic polarization compensation due to our novel approach.

TABLE 1
Advantages of Faraday rotator mirror

| Sr. | Faraday Rotator mirror advantage compared to | |
|---|---|---|
| No. | mirror mounted in air | Implications for OCT-OCDR |
| [1] | Polarization effects get cancelled due to the | Polarization insensitivity, no need for |
| | orthogonal polarization of the retroreflected light | dynamic compensation |
| [2] | Easy to assemble, no alignment needed in the | Low cost of production |
| | reference arm | |
| [3] | Part of the 3-dB coupler & reference arm assembly | Robust, rugged, compact, low-cost |

In some embodiments, we can also include a piezo-electric fiber stretcher 112 in the reference arm 102 to match the path-lengths in the reference arm 102 and sample arm 103. In other embodiments, the fiber-lengths can be chosen to match the path-lengths without using the fiber stretcher.

### 5.3.1.1 Dispersion Compensation

Group velocity dispersion needs to be matched between the reference and sample arms irrespective of using the Faraday rotating mirror. In some embodiments of our invention, dispersion is compensated numerically by flattening the Fourier domain phase of a mirror reflection as explained in [65]. The process is also known as coherent deconvolution as explained in [65] and [66]. One of the inventors has invented coherent deconvolution methods to correct for imaging artifacts in OCT [66].

5.3.2 Volume-Phase Holographic (VPH) Gratings

Typical clinical OCT systems use ruled gratings for dispersing light on a line-scan camera in the detector arm. Ruled gratings are cumbersome & expensive. In some embodiments of our invention, volume-phase holographic (VPH) grating 113, which is essentially a transmission grating with alternating refractive indices can be used. VPH gratings are highly efficient, compact, rugged, and low-cost at telecom wavelengths since these are widely used in telecom industry. VPH gratings were first developed for astronomy applications. The benefits of VPH gratings are explained as follows (Table 2):

TABLE 2
Advantages of VPH grating

| Sr. | | Implications for OCT and |
|---|---|---|
| No. | VPH grating advantage compared to ruled grating | OCDR |
| [1] | have very high diffraction efficiency approaching 100%. | high sensitivity |
| [2] | Polarization effects are not as bad as in ruled gratings, | high sensitivity |
| [3] | lack many anomalies apparent in ruled gratings. | High image quality |
| [4] | Ghosting and scattered light from a VPH grating are substantially | high sensitivity |
| | reduced compared to ruled gratings. | |
| [5] | can be tuned to shift the diffraction efficiency peak to a desired | high sensitivity |
| | wavelength. | |
| [6] | can be tuned to direct more energy into higher diffraction orders; a | high sensitivity |
| | versatility not possible with classical gratings. | |
| [7] | have high line densities (<6000 lines/mm) than ruled gratings at a | Higher scan depth, lower |
| | lower cost | cost |
| [8] | can be cleaned due to the encapsulated nature of the grating. | More life, lower cost, |
| | | higher sensitivity |
| [9] | The encapsulated nature permits antireflection coatings on the | lower cost, higher |
| | surfaces of the grating. | sensitivity |
| [10] | can be designed to work in the Littrow configuration, resulting in a | Lower cost to manufacture |
| | simplification of the line-scan camera objective optics. | |

In some embodiments of this invention, the grating disperses light and a lens focuses it into a detector array 110. By way of example, but not by limitation, this array can be a line-scan camera, which has quantum efficiency p at the operating wavelengths.

5.3.3 High Accuracy and High Precision Velocity Estimation

The data set resulting from the camera is inverse Fourier transformed, processed in a processor 114 and displayed as a gray scale or pseudo-color image. By way of example, not by limitation, this processor can be a computer, Field Programmable Gate Array (FPGA), an embedded system or a microcontroller. Here we present our version of the modified Hilbert transform algorithm:
1) CCD spectra S_{ccd}(k,x) are obtained as a function of k (wavenumber) and lateral dimension x.
2) Spectra are Fourier transformed in lateral dimension to obtain spectra P_{ccd} (k,u) where u is frequency in lateral dimension.
3) The negative frequency signals are zeroed out using Heaviside function H(u) to provide P′_{ccd}(k,u).
4) The P′_{ccd}(k,u) is inverse Fourier transformed to obtain complex spectra S′_{ccd}(k,x).
5) S′_{ccd} (k,x) is inverse Fourier transformed in k (i.e., depth) dimension to obtain Eq. 1

s(z,x)=A(z,x)exp[−j(2πfₛ(z,x)zT/D+φ(z,x))]. (Eq 1)

Here A(z,x) is the amplitude of the detected signal corresponding to the depth-resolved reflectivity obtained in conventional OCT imaging and φ(z,x) is the phase corresponding coherent interference of backscattered waves, commonly known as speckle. Here z is the depth location, x is the lateral location, D is total depth of A-scan, T is the time taken to acquire an A-scan. As discussed in [41], for a broadband source, A(z,x) is a highly localized function (e.g., a Gaussian) whose width determines the axial resolution of the OCT image. fₛ is Doppler shift in light backscattered from moving objects in the sample. A scatterer in the sample moving with a velocity Vₛ induces a Doppler shift in the sample arm light by the frequency

fₛ=2 Vₛ[cos θ]nₜv₀/c (Eq. 2)

where θ is the angle between the sample probe beam and the direction of motion of the scatterer, nₜ is the local tissue refractive index, v₀ is the source center frequency, and c is the light velocity.

The data set resulting from the camera can be processed in the processor 114 by the proposed Doppler algorithm which computes STFT (short time Fourier transforms) in lateral (x) direction.

$$\hat{S} ( z , x , f ) = {\sum }_{m = - {N}_{x} / 2}^{{N}_{x} / 2 - 1} s ( z , ( x + m D / M ) T / D ) exp [ - j2π fmT / M ] \qquad ( Eq 3 )$$

where Nₓ is the number of A-scans in the STFT window. Doppler shift is computed by adaptive centroid algorithm (which computes centroid using the power near the peak of the STFT spectrum). The velocity precision is given by

Vₛ^{up}=c/(2NₓTv₀nₜ cos θ) (Eq 4)

As we can see, velocity precision is higher with higher T (A-scan acquisition period). Therefore, in order to detect micro-flow (˜100 to 800 microns/s speed) in capillaries, by way of example but not by limitation, we can choose an A-scan rate of e.g., 2560 Ascans/s. The maximum retinal blood flow velocities typically range to 1-4 cm/s. By way of example but not by limitation, higher velocities can be measured by performing another scan at a much higher speed of 42000 Ascans/s. By way of example but not by limitation, from Eq. 4, choosing Nₓ between 1 to 30, we can measure velocities as low as 15 mm/s to 0.5 mm/s, respectively. By way of example but not by limitation, we can scan retina at 2 different scan rates, viz., 2560 Ascans/s and 42000 Ascans/s. By way of example but not by limitation, in the first set, we can scan 10 concentric circles centered at the optic disc, each consisting of 100 A-scans, which can be acquired in 4 seconds. By way of example but not by limitation, the second set would be acquired at the same locations, 10 concentric circles, each consisting of 420 A-scans, which can be acquired in 1 s.

### 5.4 Alternate Embodiments of Our OCT-OCDR System Invention

5.4.1 Use of VPH with Fiber-Integrated Mirror in the Reference Arm

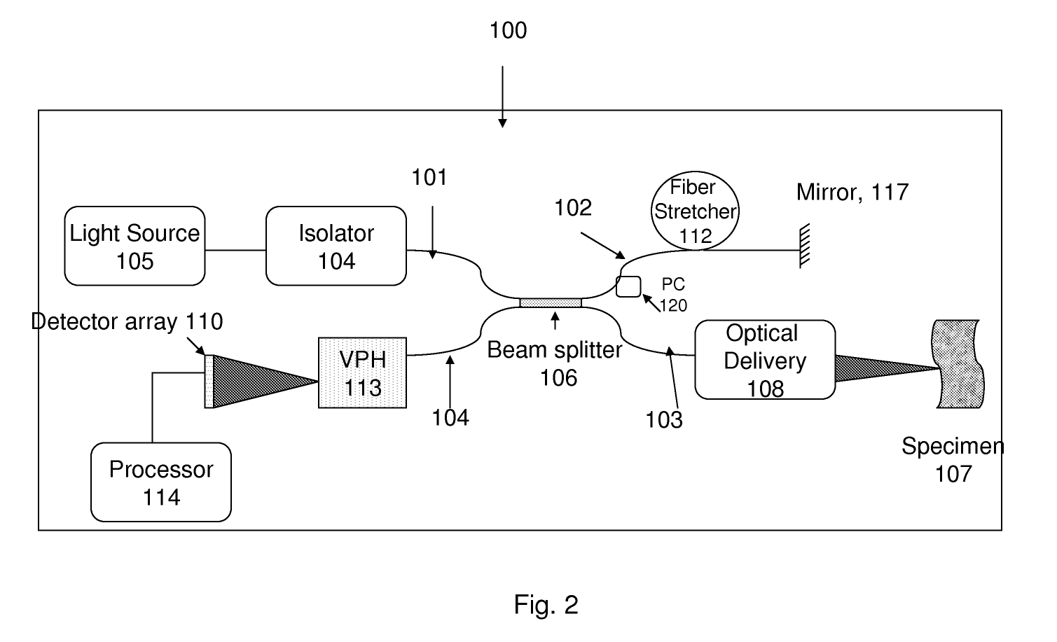

In this embodiment of our invention, (FIG. 2) the fiber-optically integrated Faraday Rotator minor 109 in the reference arm 102 of the OCT-OCDR interferometer system 100 can be replaced by a simple fiber-integrated mirror 117. Such a system can use (by way of example but not by limitation) a polarization compensator 120 in either the reference arm 102 or the sample arm 103.

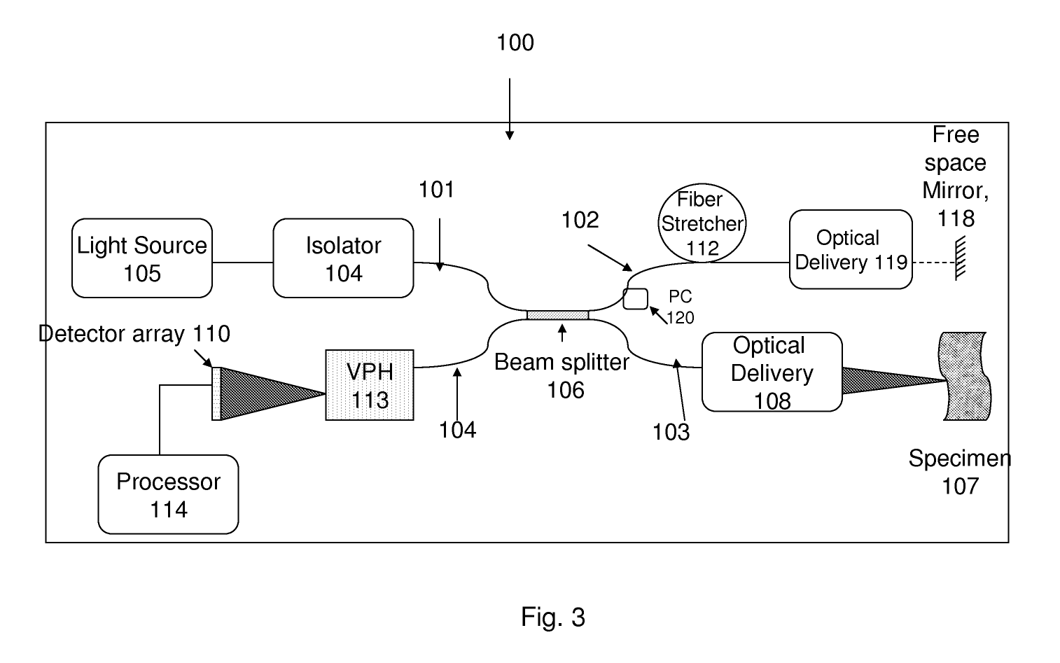

In another variation of this embodiment (FIG. 3), the fiber optically mirror can be replaced by a free space mirror 118. The light can be delivered to the mirror using optical delivery unit 119.

5.4.2 Frequency Domain OCT or Optical Frequency Domain Reflectometry

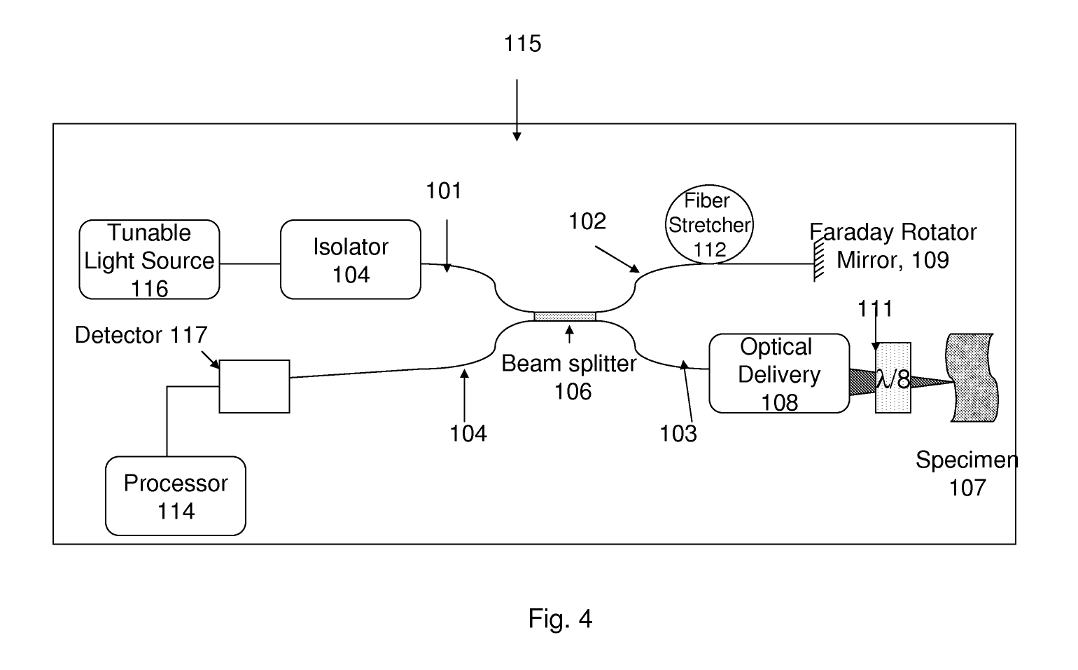

In some OCT systems such as frequency domain OCT or Optical Frequency Domain Reflectrometry (OFDR), the broad-band light source is replaced by a tunable frequency light source. The detector array is replaced by a single detector. The use of VPH is not needed for this invention. In this embodiment of our invention (FIG. 4), a fiber-optically integrated Faraday Rotator mirror 109 in the reference arm 102 of the OCT-OFDR interferometer system 115 can be used. Since the polarization of the retroreflected light is orthogonal to the incident light, fiber birefringence effects effectively get cancelled in the reference arm 102.

5.4.3 Different Types of Gratings

Volume Phase Holographic grating is a transmission grating and the diffraction is achieved by periodic modulation of the refractive index. A similar effect could be achieved by periodic modulation of grating substrate thickness instead of (or in addition to) refractive index modulation.

### 5.5 Advantages of Our Proposed Invention

Here we list how our proposed OCT product is substantially better than the existing OCT products

TABLE 3
Advantages of our proposed OCT-OCDR invention

| Sr. | Proposed feature in our | Advantage to clinician & | State-of-the-art clinical |
|---|---|---|---|
| No. | retinal OCT machine | patient | retinal OCT machines |
| [1] | Scalable, price goes down with | Increased affordability with | Price does not go down with |
| | increasing sales volume due to | device adaptation | increasing sales volume due to |
| | use of device & packaging | | use of labor intensive bulk |
| | technologies | | technologies. |
| [2] | Portable | Can be easily transported to | Not portable |
| | | remote localities | |
| [3] | Rugged & Robust | Can operate in rural challenging | Fragile, not robust |
| | | environment | |
| [4] | Use of volume holographic | Lower cost, compact, rugged | Ruled grating |
| | phase grating | | |
| [5] | Faraday rotator minor in | Lower cost, compact, rugged | Glass mirror mounted in air |
| | reference arm | | |
| [6] | Dynamic polarization control | Ease of use, patients & | Dynamic polarization control |
| | not needed due to Faraday | clinicians save valuable time | needed. |
| | mirror above. | | |

It is to be understood that the embodiments described herein can be implemented in hardware, software or a combination thereof. For a hardware implementation, the embodiments (or modules thereof) can be implemented within one or more application specific integrated circuits (ASICs), mixed signal circuits, digital signal processors (DSPs), digital signal processing devices (DSPDs), programmable logic devices (PLDs), field programmable gate arrays (FPGAs), processors, controllers, micro-controllers, microprocessors and/or other electronic units designed to perform the functions described herein, or a combination thereof.

When the embodiments (or partial embodiments) are implemented in software, firmware, middleware or microcode, program code or code segments, they can be stored in a machine-readable medium (or a computer-readable medium), such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interferometric detection metrology system, comprising:
a broadband (i.e., low-coherence length) light source optionally connected to an isolator;
a fiber optic splitter (typically 50/50) with its one arm (labeled as source arm) operably coupled to the broadband source and its second arm (labeled as sample arm) directing light onto the sample;
another arm (labeled reference arm) of the splitter operably coupled to a fiber optic Faraday rotator mirror;
and another arm (labeled detector arm) of the fiber splitter operably coupled to an optical assembly shining light on a diffraction grating and the diffracted light being imaged on a detector array;
and the means to adjust polarization in the sample arm to match the polarization in reference arm to achieve optimal signal strength;
and a processor processing the signals from the detector array for making useful measurements.

2. The system of claim 1 where polarization matching is achieved by passing the beam incident on the sample through a waveplate.

3. An interferometric ranging (Optical Coherence Domain Reflectometry (OCDR) or Optical Fourier Domain Reflectometry (OFDR)) that comprises of the interferometric detection system of claim 2.

4. An interferometric 2D imaging system (Optical coherence tomography or OCT) comprising the interferometric ranging system of claim 3 where the 2D images are obtained by laterally scanning the beam incident on the sample.

5. An interferometric 3D imaging system comprising the interferometric ranging system of claim 3 where the 3D data-sets are obtained by 2D lateral scanning the beam incident on the sample.

6. A system of claim 2 where the beam incident on the specimen is passed through a (⅛)th wave-plate.

7. The system of claim 1 where the grating used is a Volume Phase Holographic grating.

8. The system of claim 1 where a fiber stretcher is used in the reference arm to adjust the path-length.

9. A biological imaging system comprising the 2D imaging system of claim 4.

10. An ophthalmic imaging system comprising the 2D imaging system of claim 4.

11. A system of claim 1 where processing step includes Doppler processing.

12. A system of claim 11 where Doppler processing step includes STFT (short time Fourier transforms) computation in lateral (x) direction.

13. A system of claim 12 where Doppler shift is estimated by computing centroid of the STFT spectrum using power near the spectral peak.

14. An interferometric detection system, comprising:
a broadband (i.e., low-coherence length) light source optionally connected to an isolator;
a fiber optic splitter (typically 50/50) with its one arm (labeled as source arm) operably coupled to the broadband source and its second arm (labeled as sample arm) directing light onto the sample;
another arm (labeled reference arm) of the fiber optic splitter operably coupled to a fiber optic mirror;
a polarization compensator attached to either the reference arm or the sample arm of the interferometer;
and another arm (labeled detector arm) of the fiber optic splitter operably coupled to an optical assembly shining light on a volume phase holographic diffraction grating and the diffracted light being imaged on a detector array;
and a processor processing the signals from the detector array for making useful measurements.

15. An interferometric detection system, comprising:
a tunable frequency light source optionally connected to an isolator;
a fiber optic splitter (typically 50/50) with its one arm (labeled as source arm) operably coupled to the light source and its second arm (labeled as sample arm) directing light onto the sample;
another arm (labeled reference arm) of the fiber optic splitter operably coupled to a fiber optic Faraday rotator mirror;
and another arm (labeled detector arm) of the fiber optic splitter operably coupled to an optical assembly shining light on a detector transducer;
and the means to adjust polarization in the sample arm to match the polarization in reference arm to achieve optimal signal strength;
and a processor processing the signals from the detector array for making useful measurements.

16. The system of claim 2 where polarization matching is achieved by passing the beam incident on the sample through a (⅛)th waveplate.

17. The system of claim 14 where polarization matching is achieved by passing the beam incident on the sample through a waveplate.

18. The system of claim 15 where polarization matching is achieved by passing the beam incident on the sample through a (⅛)th waveplate.

19. The system of claim 14 where processing step includes Doppler processing, which includes STFT (short time Fourier transforms) computation in lateral (x) direction.

20. The system of claim 15 where processing step includes Doppler processing, which includes STFT (short time Fourier transforms) computation in lateral (x) direction.
